(19) United States
(12) Patent Application Publication
(10) Pub. No.: US 2011/0314773 A1
(43) Pub. Date: Dec. 29, 2011

(54) BANKNOTE BUNDLING DEVICE AND BANKNOTE BUNDLING METHOD

(76) Inventors: Toshihiko Suzuki, Hyogo (JP); Tomoyasu Sato, Hyogo (JP)

(21) Appl. No.: 13/255,397

(22) PCT Filed: Mar. 10, 2009
(86) PCT No.: PCT/JP2009/054557

§ 371 Date: Sep. 8, 2011

(51) Int. Cl. B65B 13/18; B65B 35/50; B65B 57/00; G07D 13/00; B65B 13/02

(52) U.S. Cl. 53/399; 53/51; 53/531

(57) ABSTRACT

A banknote bundling device (3) includes a bundling-side stacking unit (21) in which bundling-object-banknotes are sorted and stacked, a bundling unit (22) that bundles one hundred bundling-object-banknotes with a bundling tape, and a pre-bundling transport unit (25) and a hold and transport unit (27) that transports the bundling-object-banknotes stacked in the bundling-side stacking unit (21) to the bundling unit (22) when the number of the bundling-object-banknotes stacked in the bundling-side stacking unit (21) reaches one hundred. The banknote bundling device (3) further includes a banknote-kind acquisition unit (172) that acquires a banknote-kind of the last banknote stacked in the bundling-side stacking unit (21) from among the one hundred bundling-object-banknotes, and a bundling-position setting unit (174) that sets, based on the banknote-kind of the last banknote, a bundling position of the bundling tape on the bundling-object-banknotes. Consequently, the bundling position of the bundling tape can be set easily according to the banknote-kind.

### TECHNICAL FIELD

The present invention relates to a banknote bundling device and a banknote bundling method for bundling, for example, banknotes of a specific denomination into bundles of a predetermined number of banknotes.

### BACKGROUND ART

Conventionally, a banknote bundling device known (see, for example, Patent Documents 1 and 2) to the inventor includes a bundling-side stacking unit that sorts and stacks bundling-object-banknotes, a bundling unit that bundles a predetermined number of the bundling-object-banknotes with a bundling tape, and a bundle transport unit that transports the predetermined number of the bundling-object-banknotes stacked in the bundling-side stacking unit to the bundling unit when the number of the bundling-object-banknotes stacked in the bundling-side stacking unit reach a predetermined number.

For example, in a banknote bundling device disclosed in Patent Document 1, the bundling-object-banknotes in various directions, such as face-up, face-down, portrait-upright and portrait-inverted, are deposited, transported, stacked in the bundling-side stacking unit after arranging directions of face-up/down and the portrait-upright/inverted, and are bundled with the bundling tape at a fixed bundling position. Accordingly, the bundling-object-banknotes can be bundled with the bundling tape at the fixed bundling position, and the directions, face-up/down and portrait-upright/inverted, of all the bundling-object-banknotes are aligned properly.

However, in the banknote bundling device disclosed in Patent Document 1, because the bundling position of the bundling-object-banknotes is fixed irrespective of a denomination of the banknotes, the bundling position of the bundling-object-banknotes cannot be set or changed according to the denomination of the banknotes.

In contrast, in a banknote bundling device disclosed in Patent Document 2, because a stacking position of the bundling-object-banknotes within the bundling-side stacking unit can be set and changed according to the denomination of the banknotes, the bundling position of the bundling-object-banknotes can be changed according to the denomination.

Furthermore, in the banknote bundling device disclosed in Patent Document 2, because the stacking position of the bundling-object-banknotes in the bundling-side stacking unit is fixed and a holding position of the bundle transport unit that holds the bundling-object-banknotes stacked in the bundling-side stacking unit can be set and changed according to the denomination, the bundling position of the bundling-object-banknotes can be changed according to the denomination.

In the banknote bundling device disclosed in Patent Document 2, because different bundling position for each of the bundling-side stacking unit can be set, and the bundling-side stacking unit targeted for stacking can be set and changed according to the denomination, the bundling position of the bundling-object-banknotes can be changed according to the denomination.
[Patent Document 1] Japanese Patent Laid-open Application No. 2002-137862
[Patent Document 2] Japanese Patent Laid-open Application No. 2008-250982

### DISCLOSURE OF INVENTION

### Problem to be Solved by the Invention

However, a complex mechanism is required for setting and changing, according to the denomination, the stacking position in the bundling-side stacking unit, the holding position of the bundling-object-banknotes in the bundle transport unit, and the bundling-side stacking unit targeted for stacking.

In view of the above discussion, it is an object of the present invention to provide a banknote bundling device and a banknote bundling method that can freely set the bundling position of the bundling-object-banknotes without requiring a complex mechanism.

It is another object of the present invention to provide a banknote bundling device and a banknote bundling method that can significantly improve efficiency in a bundling operation of the bundling-object-banknotes without requiring a complex mechanism.

### Means for Solving the Problem

To achieve the above objects a banknote bundling device according to an aspect of the present invention includes a bundling-side stacking unit in which bundling-object-banknotes are stacked; a bundling unit that bundles the bundling-object-banknotes with a bundling tape; a bundle transport unit that transports, when the number of the bundling-object-banknotes stacked in the bundling-side stacking unit reached a predetermined number, the predetermined number of the bundling-object-banknotes to the bundling unit; a banknote-information acquisition unit that acquires banknote information from the bundling-object-banknotes; and a bundling-position setting unit that sets a bundling position of the bundling tape on the bundling-object-banknotes based on the banknote information, which is acquired by the banknote-information acquisition unit, of the banknote stacked first or last in the bundling-side stacking unit from among the predetermined number of the bundling-object-banknotes.

According to another aspect of the present invention, in the above structure, in the banknote bundling device, the bundling-position setting unit sets the bundling position of the bundling tape on the bundling-object-banknotes, based on position information of a portrait printed on a surface of the banknote included in the banknote information, such that the bundling tape is not wrapped over the portrait on the bundling-object-banknote.

According to still another aspect of the present invention, in the above structure, in the banknote bundling device, the bundling-position setting unit sets the bundling position of the bundling tape on the bundling-object-banknotes based on banknote condition information included in the banknote information.

According to still another aspect of the present invention, in the above structure, in the banknote bundling device, the bundling-position setting unit sets, based on the banknote condition information including fitness identification information that identifies whether the banknotes are fit banknotes or unfit banknotes, the bundling position of the bundling tape at a center portion of the bundling-object-banknotes when the banknotes are the unfit banknotes.

According to still another aspect of the present invention, in the above structure, in the banknote bundling device, the bundling-position setting unit sets, based on the banknote condition information including fitness identification information that identifies whether the banknotes are fit banknotes or unfit banknotes, the bundling positions of the bundling tapes at a plurality of positions on the bundling-object-banknotes when the banknotes are the unfit banknotes.

According to still another aspect of the present invention, in the above structure, in the banknote bundling device, the bundling-position setting unit sets the bundling position of the bundling tape on the bundling-object-banknotes based on denomination information included in the banknote information.

According to still another aspect of the present invention, in the above structure, in the banknote bundling device, the bundling-position setting unit manages bundling positions at one end and at the other end in a long-edge direction of the banknote, and sequentially sets the bundling position at one end or at the other end, in an alternating manner, each time the bundling-object-banknotes are bundled with the bundling tape by the bundling unit.

According to still another aspect of the present invention, in the above structure, in the banknote bundling device, the bundling-position setting unit counts, after the bundling position of the bundling tape on the bundling-object-banknotes is set, number of times the bundling-object-banknotes of the same denomination is bundled by the bundling unit with the bundling tape at the set bundling position, and sets another bundling position at a predetermined distance from the previously set bundling position in a long-edge direction of the banknote each time the number of times reaches a predetermined value.

According to still another aspect of the present invention, in the above structure, in the banknote bundling device, the bundling-position setting unit sets the bundling position of the bundling tape on the bundling-object-banknotes based on denomination information and issued printed version information included in the banknote information.

According to still another aspect of the present invention, in the above structure, in the banknote bundling device, the bundle transport unit transports the bundling-object-banknotes to the bundling unit in a state in which an edge of the bundling-object-banknotes is being held, and enables the bundling-object-banknotes to move in a long-edge direction of the banknote inside the bundling unit in the state in which the edge of the bundling-object-banknotes is being held. Moreover, the bundling unit bundles the bundling-object-banknotes with the bundling tape in the state in which the edge of the bundling-object-banknotes is held by the bundle transport unit.

According to still another aspect of the present invention, in the above structure, in the banknote bundling device, the bundle transport unit holds a short-edge of the bundling-object-banknotes.

To achieve the above objects a banknote bundling device according to still another aspect of the present invention includes a bundling-side stacking unit in which bundling-object-banknotes are stacked; a bundling unit that bundles the bundling-object-banknotes with a bundling tape; and a bundle transport unit that transports, when the number of the bundling-object-banknotes stacked in the bundling-side stacking unit reaches a predetermined number, the predetermined number of the bundling-object-banknotes to the bundling unit. The bundling unit bundles the bundling-object-banknotes with the bundling tape in a state in which the bundling-object-banknotes are being held by the bundle transport unit.

According to still another aspect of the present invention, in the above structure, in the banknote bundling device, the bundle transport unit transports the bundling-object-banknotes into the bundling unit in a state in which a short-edge of the bundling-object-banknotes is being held.

According to still another aspect of the present invention, in the above structure, in the banknote bundling device, the bundle transport unit transports a bundle of banknotes out of the bundling unit after the bundling-object-banknotes are bundled by the bundling unit with the bundling tape.

To achieve the above objects, a banknote bundling method according to still another aspect of the present invention by which bundling-object-banknotes are bundled with a bundling tape is implemented in a banknote bundling device that includes a bundling-side stacking unit in which the bundling-object-banknotes are stacked, a bundling unit that bundles the bundling-object-banknotes with the bundling tape, and a bundle transport unit that transports, when the number of the bundling-object-banknotes stacked in the bundling-side stacking unit reaches a predetermined number, the predetermined number of the bundling-object-banknotes to the bundling unit. The banknote bundling method includes acquiring banknote information of a banknote stacked first or last as the bundling-object-banknote from among the predetermined number of the bundling-object-banknotes, and setting a bundling position of the bundling tape on the bundling-object-banknotes based on the banknote information of the banknote stacked first or last.

To achieve the above objects, a banknote bundling method according to still another aspect of the present invention by which bundling-object-banknotes are bundled with a bundling tape is implemented in a banknote bundling device that includes a bundling-side stacking unit in which the bundling-object-banknotes are stacked, a bundling unit that bundles the bundling-object-banknotes with the bundling tape, and a bundle transport unit that transports, when the number of the bundling-object-banknotes stacked in the bundling-side stacking unit reach a predetermined number, the predetermined number of the bundling-object-banknotes to the bundling unit. The banknote bundling method includes bundling the bundling-object-banknotes with the bundling tape by the bundling unit in a state in which the bundling-object-banknotes are being held by the bundle transport unit.

### Advantages of the Invention

With this structure, a banknote bundling device according to the present invention sets a bundling position of a bundling tape on bundling-object-banknotes based on banknote information of a banknote stacked first or last from among a predetermined number of the bundling-object-banknotes stacked in the bundling-side stacking unit. Therefore, the bundling position of the bundling-object-banknotes can be freely set without requiring a complex mechanism.

Furthermore, in the banknote bundling device according to the present invention, the bundling position of the bundling tape on the bundling-object-banknotes is set based on position information of a portrait printed on a surface of the banknote such that the bundling tape is not wrapped over the portrait on the bundling-object-banknotes. Therefore, there is an advantage in addition to the above advantage in that situations, where wrapping the bundling tape over the portrait printed on the bundling-object-banknotes is prohibited, can be freely handled.

In the banknote bundling device according to the present invention, the bundling position of the bundling tape on the bundling-object-banknotes is set based on banknote condition information. Therefore, there is an advantage in addition to the above advantages in that a user can identify a condition of bundled banknotes, for example, a fitness condition of a bundled banknotes based on the bundling position of the bundling tape.

In the banknote bundling device according to the present invention, the bundling position of the bundling tape is set at a center portion of the bundling-object-banknote when the banknotes are unfit notes. Therefore, there is an advantage in addition to the above advantages in that the user can identify the bundle of banknotes of the unfit notes based on the bundling tape wrapped at the center portion.

In the banknote bundling device according to the present invention, the bundling positions of the bundling tapes are set at a plurality of positions on the bundling-object-banknotes when the banknotes are unfit notes. Therefore, there is an advantage in addition to the above advantages in that the user can identify the bundle of banknotes of the unfit notes based on the bundling tapes wrapped at the plurality of positions.

In the banknote bundling device according to the present invention, the bundling position of the bundling tape on the bundling-object-banknotes is set based on denomination information. Therefore, there is an advantage in addition to the above advantages in that the user can identify a denomination of the bundle of banknotes based on the bundling position of the bundling tape.

In the banknote bundling device according to the present invention, the bundling position at one end and the bundling position at the other end are sequentially set in an alternating manner each time the bundling-object-banknotes are bundled with the bundling tape. Therefore, there is an advantage in addition to the above advantages in that even if a plurality of the bundles are stacked, the bundles are stacked flatly and the bundles banknotes can be stably stacked.

In the banknote bundling device according to the present invention, after the bundling position of the bundling tape on the bundling-object-banknotes is set, the number of times the bundling-object-banknotes of the same denomination is bundled with the bundling tape at the set bundling position is counted, and another bundling position is set at a predetermined distance from the previously set bundling position in a long-edge direction of the banknote each time the number of times reaches a predetermined value. Consequently, there is an advantage in addition to the above advantages in that the user can count the bundles of banknotes of the same denomination because the bundling position is shifted by the predetermined distance, for example, 10 millimeter (mm) in the long-edge direction of the banknote after a predetermined number of the bundles, for example, five, that is, after every five bundles of banknotes.

In the banknote bundling device according to the present invention, the bundling position of the bundling tape on the bundling-object-banknotes is set based on denomination information and issued printed version information. Therefore, there is an advantage in addition to the above advantages in that the user can identify whether the bundled banknotes are new banknotes or old banknotes based on the position of the bundling tape.

In the banknote bundling device according to the present invention, the bundling-object-banknotes inside a bundling unit can be moved in the long-edge direction of the banknote, and the bundling unit can bundle the bundling-object-banknotes with the bundling tape in a state an edge of the bundling-object-banknotes is being held by a bundle transport unit. Therefore, there is an advantage in addition to the above advantages in that because the bundling-object-banknotes are bundled in the state the edge of the bundling-object-banknotes is held by the bundle transport unit, a situation, where the bundling-object-banknotes are not aligned before bundling, can be avoided. Consequently, bundling operation efficiency can be significantly improved by increasing a bundling operation speed.

In the banknote bundling device according to the present invention, the bundling-object-banknotes inside the bundling unit can be moved in the long-edge direction of the banknote, and the bundling unit can bundle the bundling-object-banknotes with the bundling tape in a state a short-edge of the bundling-object-banknotes is being held by the bundle transport unit. Therefore, there is an advantage in addition to the above advantages in that because the bundling-object-banknotes are bundled in the state the short-edge of the bundling-object-banknotes is being held by the bundle transport unit, a situation, where the bundling-object-banknotes are not aligned before bundling, can be avoided. Consequently, the bundling operation efficiency can be significantly improved by increasing the bundling operation speed.

In the banknote bundling device according to the present invention, the bundling unit bundles the bundling-object-banknotes in a state the bundling-object-banknotes are being held by the bundle transport unit. Therefore, a situation, where the bundling-object-banknotes are not aligned before bundling, can be avoided without requiring a complex mechanism, and the bundling operation efficiency can be significantly improved by increasing the bundling operation speed.

In the banknote bundling device according to the present invention, the edge held by the bundle transport unit is the short-edge of the bundling-object-banknotes. Therefore, there is an advantage in addition to the above advantages in that a situation, where the bundling-object-banknotes are not aligned before bundling, can be avoided.

In the banknote bundling device according to the present invention, the bundling-object-banknotes are bundled with the bundling tape in a state the bundling-object-banknotes are being held by the bundle transport unit, and thereafter, the bundle of banknotes is transported from the bundling unit in the state the bundle of banknotes is still being held. Therefore, there is an advantage in addition to the above advantages in that the bundle transport unit holds the bundling-object-banknotes even during the bundling operation, and therefore, the operation speed for transporting the bundle of banknotes from the bundling unit can be significantly increased.

With the structure described above, in a banknote bundling method according to the present invention, the bundling position of the bundling tape on the bundling-object-banknotes is set based on the banknote information of a banknote stacked first or last from among the predetermined number of the bundling-object-banknotes. Therefore, the bundling position of the bundling-object-banknotes can be freely set without requiring a complex mechanism.

With the structure described above, in the banknote bundling method according to the present invention, the bundling-object-banknotes are bundled in a state the bundling-object-banknotes are being held by the bundle transport unit. Therefore, a situation, where the bundling-object-banknotes are not aligned before bundling, can be avoided without requiring a complex mechanism and the bundling operation efficiency can be significantly improved by increasing the bundling operation speed.

### BRIEF DESCRIPTION OF DRAWINGS

FIG. 1 is a perspective view for clearly showing an outer appearance of a banknote sorting and bundling apparatus according to an embodiment of the present invention.

FIG. 2 is a schematic drawing of an internal structure of the banknote sorting and bundling apparatus.

FIG. 3 is a drawing for clearly explaining a reversing process performed by a banknote reversing unit.

FIG. 4 is a schematic perspective view of a structure of a bundling-side stacking unit.

FIG. 5 is a plan view of the bundling-side stacking unit with a portion thereof omitted.

FIG. 6 is a schematic block diagram of an internal structure of the banknote sorting and bundling apparatus.

FIGS. 7A to 7C are drawings for clearly explaining action transitions of a dimension adjusting mechanism of the bundling-side stacking unit.

FIGS. 8A to 8D are drawings for clearly explaining action transitions of a pre-bundling transport unit.

FIGS. 9A to 9G are drawings for clearly explaining action transitions of a hold and transport unit.

FIGS. 10A to 10C are drawings for clearly explaining an operation of the hold and transport unit on a bundling stage.

FIGS. 11A to 11K are drawings for clearly explaining action transitions of a dispensing transport unit.

FIG. 12 is a flowchart of a process processing performed by a control unit in a bundling-position setting process.

### EXPLANATIONS OF LETTERS OR NUMERALS

3: Banknote bundling device
14: Banknote recognition unit
21: Bundling-side stacking unit
22: Bundling unit
25: Pre-bundling transport unit
27: Hold and transport unit
150: Drive control unit
172: Banknote-kind acquisition unit
173: Bundling-position managing unit
174: Bundling-position setting unit
P: Bundling-object-banknote
P1: Bundle of banknotes
R: Bundling tape

### BEST MODE(S) FOR CARRYING OUT THE INVENTION

Exemplary embodiments of a banknote sorting apparatus relating to a banknote bundling device and a banknote bundling method according to the present invention are explained in detail below with reference to the accompanying drawings.

An overview of an embodiment of the present invention is explained first. The banknote bundling device includes a bundling-side stacking unit in which bundling-object-banknotes are sorted and stacked, a bundling unit that bundles a predetermined number of the bundling-object-banknotes with a bundling tape, and a pre-bundling transport unit that transports the predetermined number of the bundling-object-banknotes stacked in the bundling-side stacking unit to the bundling unit when the number of the bundling-object-banknotes stacked in the bundling-side stacking unit reaches one hundred. The banknote bundling device further includes a banknote-kind acquisition unit that acquires a banknote-kind of the bundling-object-banknotes, and a bundling-position setting unit that sets a bundling position of the bundling tape on the bundling-object-banknotes based on the banknote-kind of the banknote, stacked first or last in the bundling-side stacking unit from among the one hundred bundling-object-banknotes, acquired by the banknote-kind acquisition unit.

Consequently, in the present embodiment, because the bundling position of the bundling tape on the bundling-object-banknotes is set based on the banknote-kind of the banknote stacked first or last in the bundling-side stacking unit from among the one hundred bundling-object-banknotes, the bundling position of the bundling-object-banknotes can be freely set without requiring a complex structure.

### Embodiments

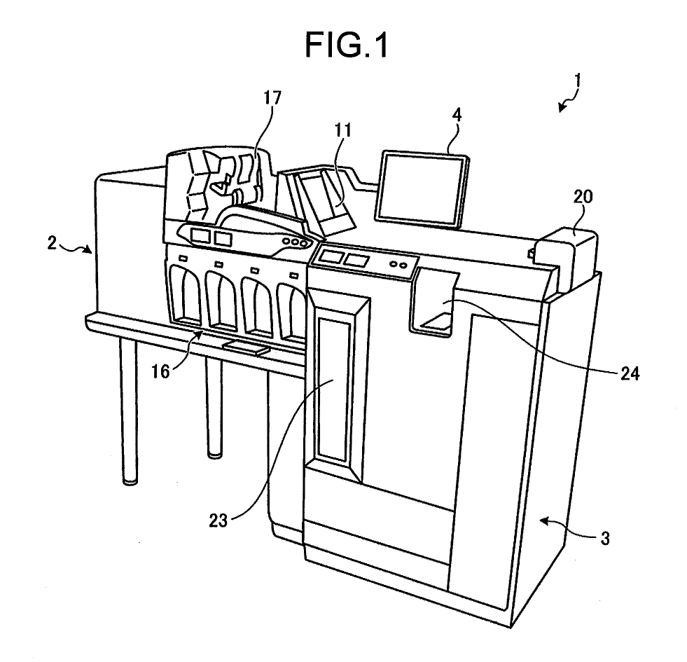

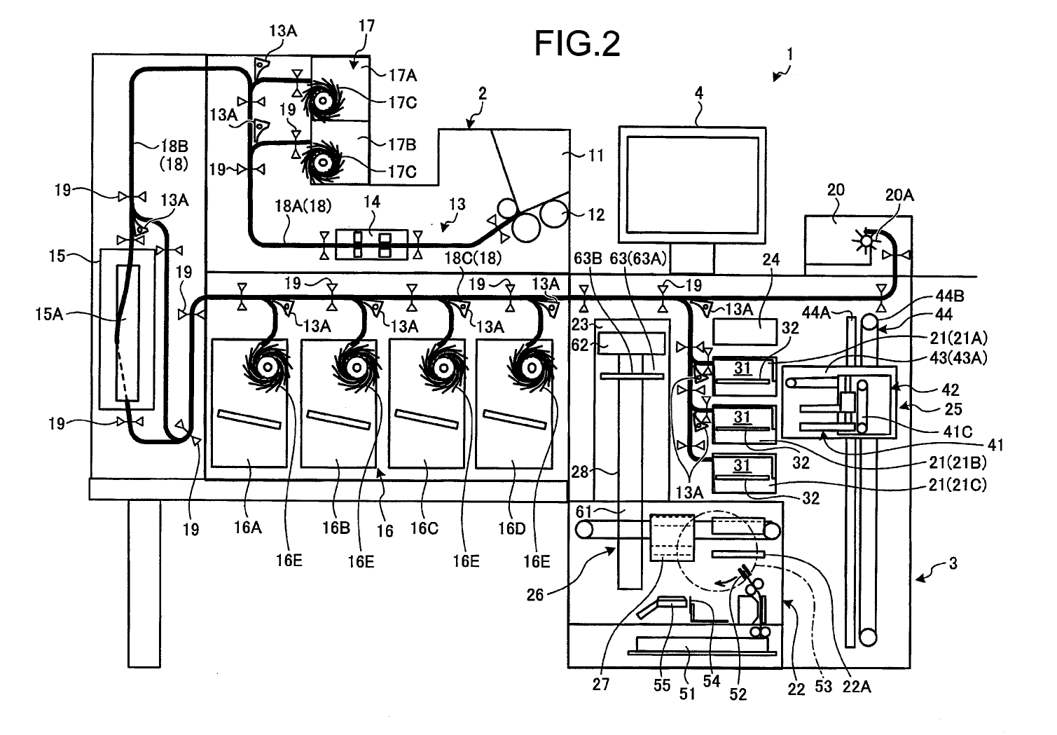

FIG. 1 is a perspective view for clearly showing an appearance of a banknote sorting and bundling apparatus according to a first embodiment of the present invention. FIG. 2 is a schematic drawing of an internal structure of the banknote sorting and bundling apparatus.

A banknote sorting and bundling apparatus 1 includes a banknote processing device 2, a banknote bundling device 3, and a display device 4. The banknote processing device 2 accepts continuous deposits of banknotes in transaction as well, sorts and stacks the deposited banknotes by banknote-kind, and counts the deposited number of banknotes by banknote-kind. The banknote bundling device 3 bundles a predetermined number of banknotes, for example, every one hundred banknotes, of a specific denomination sorted by the banknote processing device 2, and the display device 4 displays various information such as a count result.

The banknote processing device 2 includes a hopper unit 11 for depositing banknotes in transaction into the apparatus, a feeding unit 12 that feeds the banknotes, one by one, deposited in the hopper unit 11, a banknote transport unit 13, such as a transport belt, that transports the banknotes fed by the feeding unit 12, a banknote recognition unit 14 that recognizes the kind of the banknote transported by the banknote transport unit 13, and a banknote reversing unit 15 that reverses the banknote transported by the banknote transport unit 13 based on face/back information obtained from the banknote recognition unit 14 so that all the banknotes face in the same direction, either face-up or face-down.

The banknote processing device 2 further includes four stackers 16 for sorting and stacking the banknotes transported by the banknote transport unit 13 according to kind of the banknote, and two first reject units 17 for rejecting the banknotes that are not of the banknote-kind corresponding to the stackers 16 and the banknote bundling device 3. A stacking wheel 16E (17C) that stacks the banknote that is being transported, one at a time, at a predetermined position in a banknote stacking space, is arranged in each of the stackers 16 and the first reject units 17.

The four stackers 16 for sorting and stacking the transported banknotes based on kind of banknote comprise a first stacker 16A, a second stacker 16B, a third stacker 16C, and a fourth stacker 16D. The term banknote-kind refers to, if Euro is taken as an example, the seven denominations of Euro, namely, 5 Euro banknote, 10 Euro banknote, 20 Euro banknote, 50 Euro banknote, 100 Euro banknote, 200 Euro banknote, and 500 Euro banknote, as well as authentication information that identifies a genuine note or a counterfeit note, fitness information that identifies a fit note or an unfit note, face/back information that identifies the banknote is face-up or a face-down, etc. In case of other currencies, the banknote-kind also includes printed version information, etc., that identifies a new note or an old note for each denomination.

The banknote bundling device 3 includes the banknote transport unit 13 that transports the banknote of the specific denomination from a banknote transport path 18 inside the banknote processing device 2 into the banknote bundling device 3, three bundling-side stacking units 21 that are arranged at three levels in a vertical direction inside the banknote bundling device 3 for sorting and stacking the transported banknotes of the specific denomination, and a bundling unit 22 that is arranged below the three bundling-side stacking units 21 for bundling the bundling-object-banknotes sorted and stacked in the bundling-side stacking unit 21 when the number of bundling-object-banknotes reaches a predetermined number, for example, one hundred.

The banknote bundling device 3 further includes a bundle dispensing outlet 23 that is located near the hopper unit 11 and that dispenses the banknotes bundled by the bundling unit 22, that is the bundle of banknotes, so that the operator can collect them, and a loose-banknotes returning outlet 24 that is located near the bundling-side stacking unit 21 and that dispenses loose banknotes stacked in the bundling-side stacking unit 21 at the end of a transaction so that the operator can collect them.

The banknote bundling device 3 includes a pre-bundling transport unit 25 that transports the bundling-object-banknotes stacked in the bundling-side stacking unit 21 to the bundling unit 22 or the loose-banknotes returning outlet 24, and a post-bundling transport unit 26 that holds and transports the bundling-object-banknotes in the bundling unit 22 in a long-edge direction and transports a bundle of banknotes bundled by the bundling unit 22 to the bundle dispensing outlet 23.

The pre-bundling transport unit 25 holds, from a long-edge side, the one hundred bundling-object-banknotes from among the bundling-object-banknotes stacked in the bundling-side stacking unit 21 and transports the one hundred bundling-object-banknotes onto a bundling stage 22A inside the bundling unit 22. At the end of a transaction, the pre-bundling transport unit 25 holds the loose banknotes, whose number does not reach one hundred, from among the bundling-object-banknotes stacked in the bundling-side stacking unit 21 and transports the loose banknotes to the loose-banknotes returning outlet 24. The bundling stage 22A of the bundling unit 22 corresponds to a bundling operation area of the bundling unit 22.

The post-bundling transport unit 26 includes a hold and transport unit 27 and a dispensing transport unit 28. The hold and transport unit 27 holds, from a short-edge side, the bundling-object-banknotes that are transported onto the bundling stage 22A inside the bundling unit 22 by the pre-bundling transport unit 25, transports the held bundling-object-banknotes in the long-edge direction of the banknote, and holds and transports the bundle of banknotes bundled by the bundling unit 22. The dispensing transport unit 28 transports the bundle of banknotes held and transported by the hold and transport unit 27 to the bundle dispensing outlet 23.

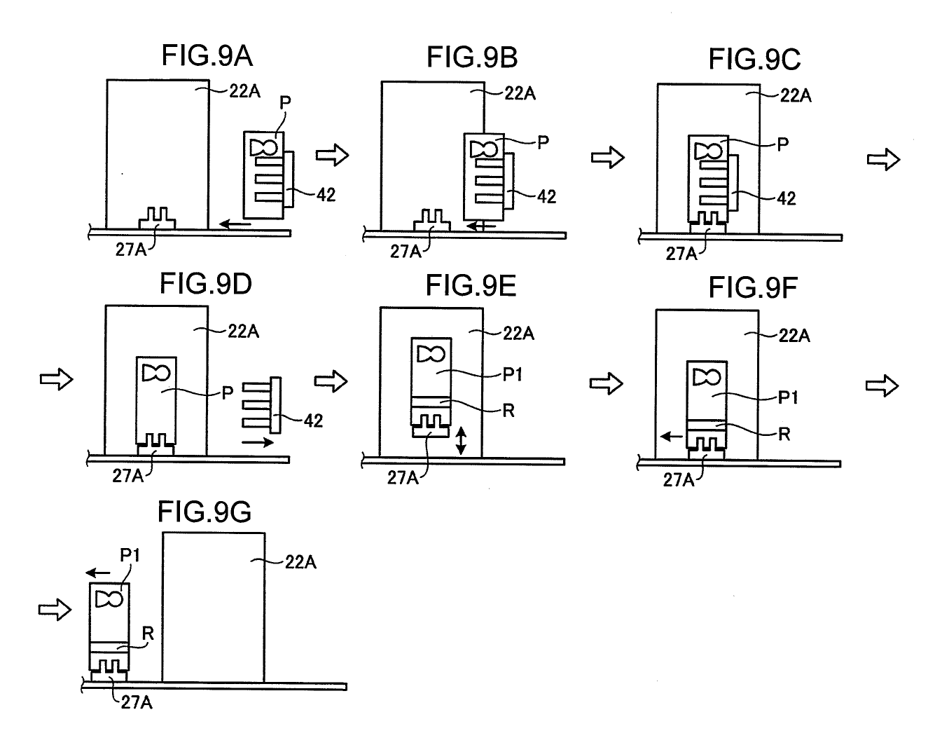

The hold and transport unit 27 holds, from the short-edge side, the bundling-object-banknotes at an operation preparation position after that are transported to the operation preparation position on the bundling stage 22A inside the bundling unit 22 by the pre-bundling transport unit 25 (see FIG. 9C that is described later). The pre-bundling transport unit 25 releases its hold of the long-edge of bundling-object-banknotes as the hold and transport unit 27 holds the bundling-object-banknotes from the short-edge side.

The operation preparation position is a position from where the bundling-object-banknotes are moved and adjusted toward a bundling operation position on the bundling stage 22A where a bundling operation is performed, that is, a position from where an adjustment of the bundling-object-banknote starts in a long-edge direction. The bundling operation position is a position at which the bundling-object-banknotes are bundled with the bundling tape.

Upon holding the bundling-object-banknotes at the operation preparation position on the bundling stage 22A of the bundling unit 22, the hold and transport unit 27 moves and adjusts the position of the bundling-object-banknotes in the long-edge direction so that the bundling position of the bundling-object-banknotes is set at the bundling operation position on the bundling stage 22A (see FIG. 9E that is described later). The bundling unit 22 wraps the bundling tape around the bundling-object-banknotes at the bundling position by setting the bundling position of the bundling-object-banknotes at the bundling operation position.

When bundling of the bundling-object-banknotes by the bundling unit 22 is completed at the bundling operation position on the bundling stage 22A in a state the bundling-object-banknotes are being held by the hold and transport unit 27 from the short-edge side, the hold and transport unit 27 transports the bundle of banknotes to the operation preparation position and subsequently into the dispensing transport unit 28.

The dispensing transport unit 28 includes a bundled-banknotes lifting unit 61 that transports the bundle of banknotes held and transported by the hold and transport unit 27 to an upper part of the banknote bundling device 3, a pushing mechanism 62 that pushes the bundle of banknotes, transported to the upper part of the banknote bundling device 3 by the bundled-banknotes lifting unit 61, towards the bundle dispensing outlet 23 (towards a front side of the apparatus), and a dispense/hold mechanism 63 that receives the bundle of banknotes pushed to the front side of the apparatus by the pushing mechanism 62 and holds the bundle of banknotes at the position of the bundle dispensing outlet 23 for dispensing the bundle of banknotes.

The banknote sorting and bundling apparatus 1 further includes the banknote transport path 18 that includes a first transport path 18A that is connected to the hopper unit 11 and that is arranged above the stackers 16, a second transport path 18B that is connected to the first transport path 18A and that bends back in an arrangement direction of the stackers 16, and the third transport path 18C that is connected to the second transport path 18B, the stackers 16, and the bundling-side stacking unit 21. The banknote recognition unit 14 is arranged on the first transport path 18A and the banknote reversing unit 15 is arranged on the second transport path 18B. The second transport path 18B is configured as a removable unit that connects the first transport path 18A and the third transport path 18C of the banknote sorting and bundling apparatus 1.

On the banknote transport path 18, a detection sensors 19 for detecting approaches or passes of banknotes at each branching point, merging point, and device linkage point between the devices are arranged at each of the above-mentioned points on the banknote transport path 18.

A second reject unit 20 is arranged at the end of the third transport path 18C. A banknote aligner wheel 20A that stacks the transported banknote, one at a time, at a predetermined position in a banknote stacking space is arranged in the second reject unit 20.

A diverting unit 13A is arranged at each of the branching points on the banknote transport path 18. The diverting unit 13A diverts the banknote transported through the banknote transport path 18 to the stackers 16, the bundling-side stacking unit 21, the first reject units 17 or the second reject unit 20. The diverting unit 13A is driven by a not shown solenoid when the detection sensor 19 detects an approach of a leading edge of the banknote, and performs the diverting of the banknote.

The banknote reversing unit 15 diverts the banknote, based on the face/back information obtained from the banknote recognition unit 14, into a reversing route or a non-reversing route by the diverting unit 13A that is arranged upstream of the banknote reversing unit 15 so that all the banknotes are transported through the third transport path 18C with faces in the same direction, either face-up or face-down.

The reversing route includes a reversing member 15A that has a curved surface and that extends along a transport direction of the banknote, a not shown transport belt that is winded obliquely relative to a longitudinal direction of the reversing member 15A with a part of the transport belt running along the curved surface of the reversing member 15A, a not shown driving motor that drives the transport belt, and a not shown guide unit guiding the banknote while the banknote is transported, in the longitudinal direction of the reversing member 15A, in the state of being wrapped around the curved surface of the reversing member 15A and is held between the transport belt and the reversing member 15A (see Japanese Patent No. 4119664).

In the banknote reversing unit 15, when the transport belt is being driven by the driving motor, the banknote moves in the transport direction as the transport belt moves while the banknote is being held between the transport belt and the reversing member 15A. Because the transport belt is winded obliquely relative to the longitudinal direction of the reversing member 15A, the banknote is transported in the state of being wrapped around the curved surface and is reversed during the transport. During the reversing of the banknote, the guide unit ensures that the banknote is reversed properly by restricting a movement of the banknote and guiding so that the banknote is slid on the surface of the guide unit.

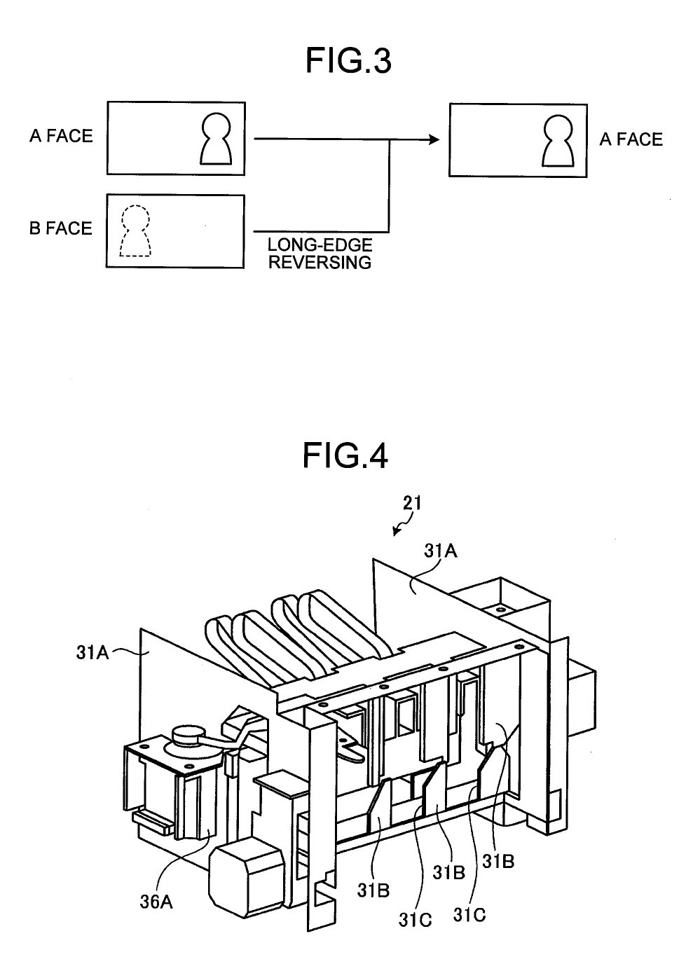

FIG. 3 is a drawing for clearly explaining a reversing process performed by the banknote reversing unit 15.

When transporting the banknote with an A face (front face), shown in FIG. 3, to the third transport path 18C, the banknote reversing unit 15 transports the banknote via a non-reversing route without performing a reversing process so that the banknote with the A face (front face) is transported to the third transport path 18C.

When transporting the banknote with a B face (back face), shown in FIG. 3, to the third transport path 18C, the banknote reversing unit 15 transports the banknote with the B face via a reversing route by performing a long-edge direction reversing process so that the banknote is reversed, and therefore, the banknote with the A face (front face) is transported to the third transport path 18C.

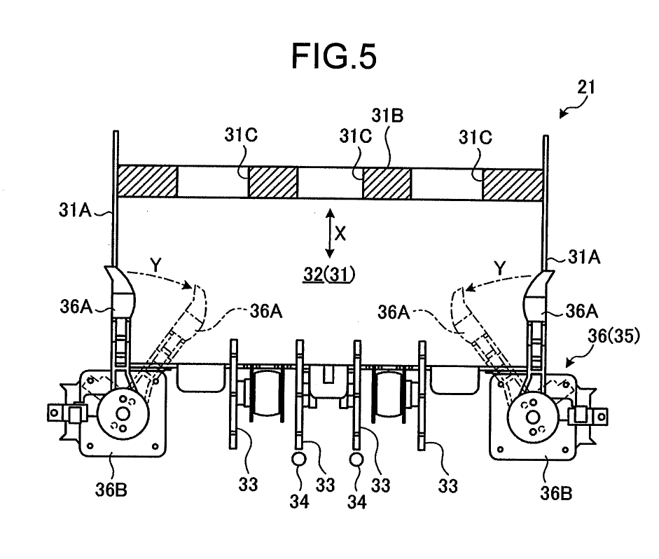

FIG. 4 is a schematic perspective view of a structure of the bundling-side stacking unit 21. FIG. 5 is a plan view of the bundling-side stacking unit 21 with a portion thereof omitted.

The bundling-side stacking unit 21 includes a stage member 32, banknote aligner wheels 33, approach detecting sensors 34, and a dimension adjusting mechanism 35. The stage member 32 on which the banknotes are stacked is arranged in a stacking space 31 formed by left side and right side walls 31A and a back side wall 31B, and can be moved up and down. The banknote aligner wheels 33 stack the banknote that is transported in the stacking space 31, and adjust a position of the stacked banknotes. The approach detecting sensors 34 detect an approach of the banknote being transported into the stacking space 31. The dimension adjusting mechanism 35 adjusts the stacking space 31 according to dimensions that is set for a banknote to be stacked in the bundling-side stacking unit 21. To maintain a constant position of the banknote stacked topmost, in the height direction of the stacked banknotes, the stage member 32 is gradually lowered as the banknotes are stacked.

The dimension adjusting mechanism 35 includes a banknote aligning mechanism 36 and a short-edge dimension adjusting mechanism 37 (not shown). The banknote aligning mechanism 36 adjusts a position of the bundling-object-banknotes stacked in the stacking space 31 in a longitudinal direction according to the dimensions set for the banknote to be stacked therein. The short-edge dimension adjusting mechanism 37 adjusts a short-edge dimension of the stacking space 31 according to the dimensions set for the banknote to be stacked therein.

The banknote aligning mechanism 36 includes left and right arm units 36A that are swingably arranged at the end portion of each of the left side and right side walls 31A and swing toward a direction Y inside the stacking space 31, and stepping motors 36B that swing the left and right arm units 36A to the set positions according to the set banknote. The banknote aligning mechanism 36 adjusts the position of the stacked banknotes in the longitudinal direction by tapping the side edges of the stacked banknotes stacked on the stage member 32 in the stacking space 31 with free ends of the left and right arm units 36A that have been swung to the set swing position according to the set banknote.

The short-edge dimension adjusting mechanism 37 enables movement of the back side wall 31B of the stacking space 31 in front-back direction X of banknote transportation, and adjusts the short-edge dimension of the stacking space 31 according to the short-edge dimension set for the banknote to be stacked in the stacking space 31.

Three openings 31C are provided through the back side wall 31B to allow a hand unit 41 (see FIG. 2) of the pre-bundling transport unit 25 to advance into the stacking space 31 and hold the bundling-object-banknotes stacked in the stacking space 31. A shutter mechanism that can be opened and closed is provided below the back side wall 31B to allow the hand unit 41 to pull out the bundling-object-banknotes from the stacking space 31.

As shown in FIG. 2, the pre-bundling transport unit 25 includes a transport unit 42 that has the hand unit 41 that holds a long-edge of bundling-object-banknotes bundle stacked in the bundling-side stacking unit 21, a horizontal movement mechanism 43 that moves the transport unit 42 forward and backward (horizontal direction), and a vertical movement mechanism 44 that moves the transport unit 42 upward and downward (vertical direction).

The vertical movement mechanism 44 includes a guiding shaft 44A that is vertically placed and that extends from a bottom end to a top end of the banknote bundling device 3, and a driving belt 44B that raises and lowers the transport unit 42 along the guiding shaft 44A.

The transport unit 42 arranged in the pre-bundling transport unit 25 includes the hand unit 41 that can be moved forward and backward by a driving belt 43A arranged in the horizontal movement mechanism 43. The hand unit 41 includes an upper hand 41A with three holding pawls and a lower hand 41B with three holding pawls facing each other and holds the bundling-object-banknotes stacked in the bundling-side stacking unit 21 with the opposing sets of holding pawls. The lower hand 41B is fixed whereas the upper hand 41A is movable up and down by a driving belt 41C.

The transport unit 42 holds, from the long-edge side, the bundling-object-banknotes by the opposing holding pawls of the upper hand 41A and the lower hand 41B, and transports the bundling-object-banknotes to the operation preparation position on the bundling stage 22A inside the bundling unit 22 or to the loose-banknotes returning outlet 24.

The pre-bundling transport unit 25 transports the one hundred bundling-object-banknotes, with the long-edge of the bundling-object-banknotes held by the transport unit 42, to the operation preparation position on the bundling stage 22A inside the bundling unit 22.

The hold and transport unit 27 holds, from the short-edge side, the one hundred bundling-object-banknotes at the operation preparation position on the bundling stage 22A inside the bundling unit 22 in a state the bundling-object-banknotes are being held from the long-edge side by the transport unit 42. As the hold and transport unit 27 holds the short-edge of the bundling-object-banknotes, the transport unit 42 inside the pre-bundling transport unit 25 releases its hold of the long-edge of the bundling-object-banknotes and moves to a standby position.

The hold and transport unit 27 includes a holding unit 27A having upper and lower hands that together hold the banknotes from the short-edge side. The holding unit 27A holds and transports the bundling-object-banknotes from the operation preparation position, in the long-edge direction, so that the bundling position of the bundling-object-banknotes is aligned with the bundling operation position on the bundling stage 22A.

When the bundling position of the bundling-object-banknotes is aligned with the bundling operation position on the bundling stage 22A in a state the short edge of the bundling-object-banknotes are being held by the holding unit 27A inside the hold and transport unit 27, the bundling unit 22 bundles the bundling-object-banknotes with the bundling tape at the bundling position.

The bundling unit, 22 that makes the bundle of banknotes by bundling the bundling-object-banknotes with the bundling tape, includes a bundling tape reel 51 on which the bundling tape is winded, a bundling tape stopper 52 that stops a leading edge of the bundling tape being drawn from the bundling tape reel 51 at a bundling position of the bundling-object-banknotes that is aligned with the bundling operation position, a swinging arm 53 that draws, from the bundling tape reel 51, the bundling tape of which the leading edge has been stopped at the bundling position of the bundling-object-banknotes and wraps the bundling tape around the bundling-object-banknotes at the bundling position, a cutter 54 that cuts the other end of the bundling tape after the bundling-object-banknotes have been wrapped at the bundling position, and a heater 55 that thermally bonds the other end of the bundling tape cut by the cutter 54.

When bundling of the bundling-object-banknotes by the bundling unit 22 is completed, the holding unit 27A of the hold and transport unit 27 returns the bundle of banknotes to the operation preparation position and transports it into the bundled-banknotes lifting unit 61 inside the dispensing transport unit 28. Furthermore, the hold and transport unit 27 releases its hold of the bundle of banknotes on the short-edge when the bundle of banknotes is transported into the bundled-banknotes lifting unit 61.

The bundled-banknotes lifting unit 61 transports the bundle of banknotes held and transported by the hold and transport unit 27 toward the pushing mechanism 62 in the upper part of the banknote bundling device 3.

The pushing mechanism 62 pushes and transports the bundle of banknotes to the dispense/hold mechanism 63 in a direction of the bundle dispensing outlet 23 (towards the front side of the apparatus) by pushing the bundle of banknotes transported to the upper part of the banknote bundling device 3 by the bundled-banknotes lifting unit 61.

The dispense/hold mechanism 63 includes a bundled-banknotes stacking unit 63A in which the bundle of banknotes, that is pushed and transported by the pushing mechanism 62, is stacked, and a bundled banknotes stage 63B for placing the bundle of banknotes stacked in the bundled-banknotes stacking unit 63A. The dispense/hold mechanism 63 adjusts a height of the bundled banknotes stage 63B so that the bundle of banknotes pushed by the pushing mechanism 62 comes to rest on the topmost bundle of banknotes resting on the bundled banknotes stage 63B.

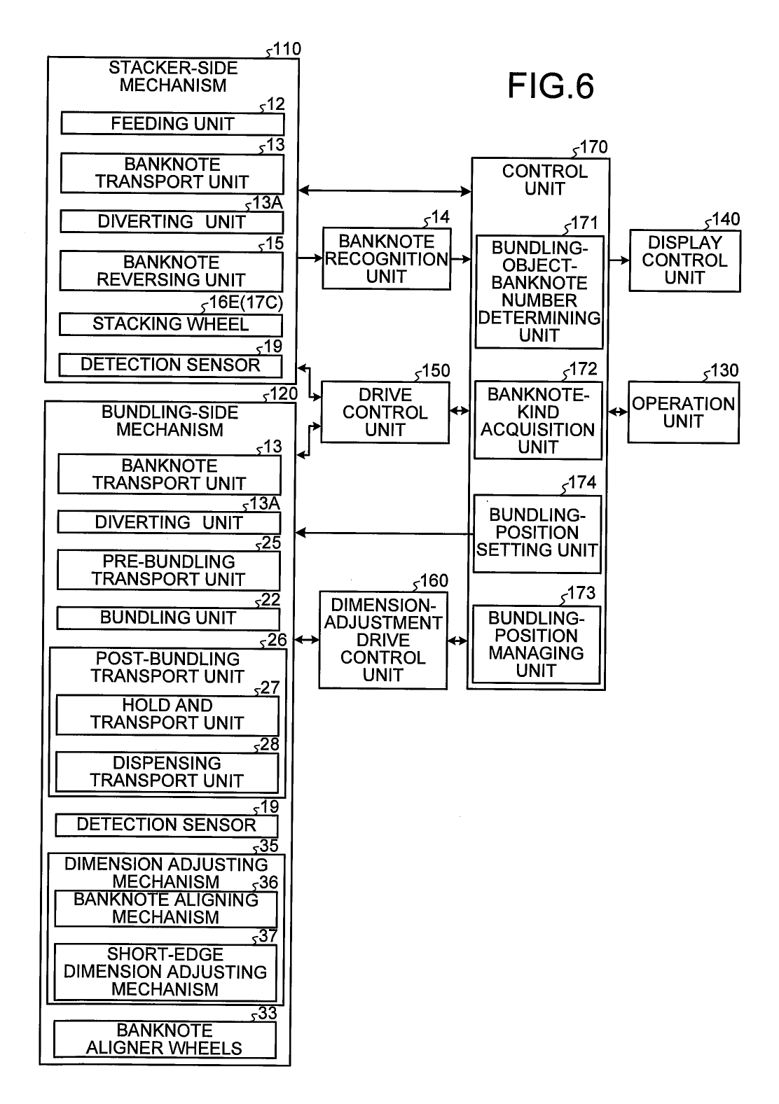

FIG. 6 is a schematic block diagram of internal structure of the banknote sorting and bundling apparatus 1.

The banknote sorting and bundling apparatus 1 includes, apart from the banknote recognition unit 14, a stacker-side mechanism 110 arranged inside the banknote processing device 2, a bundling-side mechanism 120 arranged inside the banknote bundling device 3, an operation unit 130 for inputting various commands, a display control unit 140 that performs a display control of the display device 4, a drive control unit 150 that performs a drive control of the stacker-side mechanism 110 and the bundling-side mechanism 120, a dimension-adjustment drive control unit 160 that performs an adjustment control of the dimension adjusting mechanism 35 arranged inside the bundling-side mechanism 120, and a control unit 170 that performs an overall control of the banknote sorting and bundling apparatus 1.

The stacker-side mechanism 110 includes the feeding unit 12, the banknote transport unit 13, the banknote reversing unit 15, the stacking wheel 16E (17C), the detection sensors 19 arranged in the banknote processing device 2, and the diverting units 13A.

The bundling-side mechanism 120 includes the detection sensors 19 arranged in the banknote bundling device 3, the banknote transport unit 13, the diverting units 13A, the bundling unit 22, the pre-bundling transport unit 25, the post-bundling transport unit 26, the dimension adjusting mechanism 35, and the banknote aligner wheels 33. The post-bundling transport unit 26 includes the hold and transport unit 27 and the dispensing transport unit 28. The dimension adjusting mechanism 35 includes the banknote aligning mechanism 36 and the short-edge dimension adjusting mechanism 37.

The control unit 170 sets the banknote-kind to be stacked (stacking banknote) in each of the stackers 16, the first reject units 17, the second reject unit 20, and the bundling-side stacking units 21. For example, the control unit 170 sets 5 Euro banknote for the first stacker 16A, 50 Euro banknote for the second stacker 16B, 100 Euro banknote for the third stacker 16C, 200 Euro banknote for the fourth stacker 16D, 500 Euro banknote for a first reject unit 17A, and further sets, as initial settings, 10 Euro banknote for a first bundling-side stacking unit 21A, 20 Euro banknote for a second bundling-side stacking unit 21B, and a spare for a third bundling-side stacking unit 21C. The first reject unit 17A can be used as a stacker for stacking rare kinds of banknotes such as 500 Euro banknotes.

The control unit 170 also identifies errors such as jamming of the banknotes on the transport path, based on a detection result of the detection sensors 19.

The control unit 170 includes a bundling-object-banknote number determining unit 171 that determines whether the number of the bundling-object-banknotes stacked in one of the three bundling-side stacking units 21 has reached one hundred, a banknote-kind acquisition unit 172 that acquires a banknote-kind of the last banknote stacked in the bundling-side stacking unit 21 from among the one hundred bundling-object-banknotes when the bundling-object-banknote number determining unit 171 determines that the number of the bundling-object-banknotes stacked in the bundling-side stacking unit 21 has reached one hundred, a bundling-position managing unit 173 that registers and manages the bundling position according to the banknote-kind, and a bundling-position setting unit 174 that acquires the bundling position, corresponding to the banknote-kind acquired by the banknote-kind acquisition unit 172, from the bundling-position managing unit 173, and sets the acquired bundling-position.

When the number of the bundling-object-banknotes stacked in any one of the first bundling-side stacking unit 21A, the second bundling-side stacking unit 21B, and the third bundling-side stacking unit 21C has reached one hundred, based on the recognition results obtained by the banknote recognition unit 14, the banknote-kind acquisition unit 172 acquires the banknote of the last banknote from among the one hundred bundling-object-banknotes stacked in the relevant bundling-side stacking unit 21, that is, the uppermost banknote of the stacked bundling-object-banknotes.

The bundling-position managing unit 173 manages the bundling position in the long-edge direction of the banknote by banknote-kinds.

When the banknote-kind acquisition unit 172 acquires the banknote-kind of the last banknote from among the stacked bundling-object-banknotes, the bundling-position setting unit 174 reads the bundling position, corresponding to the banknote-kind, from the bundling-position managing unit 173 and sets the read bundling position in the drive control unit 150.

As a result, based on the bundling position set by the bundling-position setting unit 174, the drive control unit 150 controls the holding unit 27A of the hold and transport unit 27 so that the bundling position of the bundling-object-banknotes is aligned with the bundling operation position on the bundling stage 22A of the bundling unit 22.

Upon receiving the banknote-kind of the transported banknote recognized by the banknote recognition unit 14, if the banknote being transported through the banknote transport path 18 is of the banknote-kind (stacking banknote) set for any one of the stackers 16 or the bundling-side stacking unit 21, the drive control unit 150 performs the drive control of the banknote transport unit 13 and the diverting units 13A so that the banknote being transported is sorted and stacked in the stacker 16 or the bundling-side stacking unit 21 corresponding to the banknote-kind.

If the banknote being transported through the banknote transport path 18 is not of the banknote-kind set for any one of the stackers 16 or the bundling-side stacking unit 21, or the banknote cannot be recognized due to transport error, etc., the drive control unit 150 performs the drive control of the banknote transport unit 13 and the diverting units 13A so that the banknote is transported to the first reject unit 17.

If the banknote being transported through the banknote transport path 18 is of the banknote-kind (stacking banknote) that is set for the bundling-side stacking unit 21, the drive control unit 150 performs the drive control of the banknote transport unit 13 and the diverting units 13A so that the transported banknote is sorted and stacked in the bundling-side stacking unit 21.

For example, if the banknote-kind (stacking banknote) set for the first bundling-side stacking unit 21A is 10 Euro banknote, the banknote-kind set for the second bundling-side stacking unit 21B is 20 Euro banknote, and the third bundling-side stacking unit 21C is set as a spare stacking unit, and if the number of the bundling-object-banknotes stacked in the first bundling-side stacking unit 21A has reached one hundred, the drive control unit 150 performs the drive control of the pre-bundling transport unit 25 so that the hand unit 41 arranged in the transport unit 42 of the pre-bundling transport unit 25 draws out the bundling-object-banknotes stacked in the first bundling-side stacking unit 21A.

When the number of the 10 Euro banknotes stacked in the first bundling-side stacking unit 21A reaches one hundred, the control unit 170 switches the banknote-kind (stacking banknote) for the spare third bundling-side stacking unit 21C to 10 Euro banknote, and once the one hundred banknotes of 10 Euro banknote are drawn out by the hand unit 41 arranged in the transport unit 42, switches the banknote-kind (stacking banknote) for the first bundling-side stacking unit 21A to the spare.

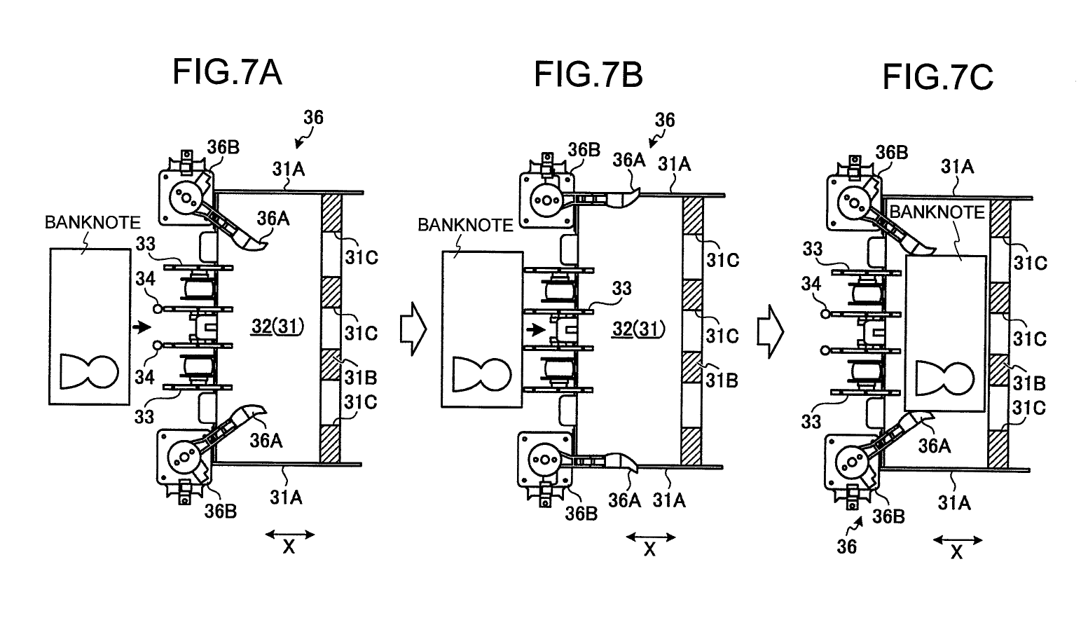

When the number of 10 Euro banknotes stacked in the first bundling-side stacking unit 21A reaches one hundred, and the banknote-kind (stacking banknote) for the spare third bundling-side stacking unit 21C is set as 10 Euro banknote, the dimension-adjustment drive control unit 160 performs the drive control of the dimension adjusting mechanism 35 of the third bundling-side stacking unit 21C so that the third bundling-side stacking unit 21C is adjusted according to the banknote dimension of the set banknote, that is, the 10 Euro banknote. The dimension-adjustment drive control unit 160 manages, for every banknote-kind, the swing positions of the arm units 36A arranged in the banknote aligning mechanism 36 and the short-edge dimension of the short-edge dimension adjusting mechanism 37. [0110] FIGS. 7A to 7C are drawings for clearly explaining action transitions of the dimension adjusting mechanism 35 of the bundling-side stacking unit 21.

The dimension-adjustment drive control unit 160 performs the drive control of the short-edge dimension adjusting mechanism 37 so that the stacking space 31 is adjusted by moving the back side wall 31B in the X direction according to the banknote set to be stacked therein. In addition, the dimension-adjustment drive control unit 160 performs the drive control of the banknote aligning mechanism 36 so that the swing positions of the arm units 36A of the banknote aligning mechanism 36 are set according to a long-edge dimension of the set banknote.

The dimension-adjustment drive control unit 160 first performs the drive control so that the back side wall 31B is moved to a position according to the short-edge dimension of the set banknote, and the arm units 36A of the banknote aligning mechanism 36 are held at the set swing positions according to the set long-edge dimension (see FIG. 7A).

Upon detection of the banknote approaching the stacking space 31 by the approach detecting sensors 34, the dimension-adjustment drive control unit 160 performs the next drive control so that the left and right arm units 36A are wide opened (see FIG. 7B).

After a lapse of a predetermined time period after the approach detecting sensors 34 detect that the banknote has passed the sensors, the dimension-adjustment drive control unit 160 performs the next drive control so that the left and right arm units 36A swing to the set swing positions to adjust the position of the banknote stacked in the stacking space 31 in the longitudinal direction with the free ends of the left and right arm units 36A (see FIG. 7C).

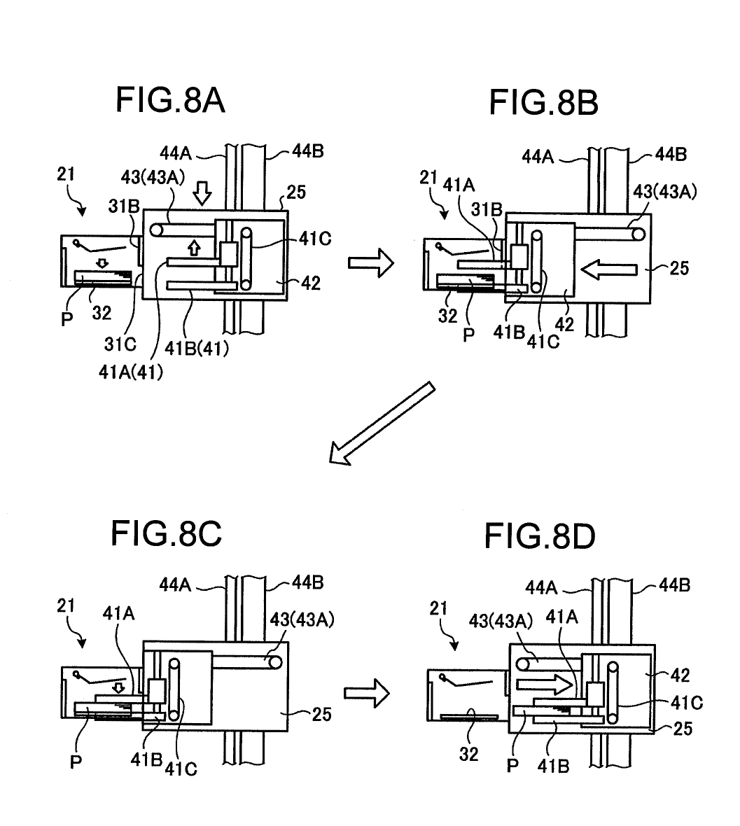

FIGS. 8A to 8D are drawings for clearly explaining action transitions of the pre-bundling transport unit 25.

When the bundling-object-banknotes stacked in the bundling-side stacking unit 21 are drawn out by the transport unit 42, the pre-bundling transport unit 25 moves, downward to a level of the lowermost edge, the stage member 32 arranged in the bundling-side stacking unit 21 in which the bundling-object-banknotes to be drawn out are stacked (see FIG. 8A).

The transport unit 42 of the pre-bundling transport unit 25, through the action of the driving belt 44B, moves downward along the guiding shaft 44A to a position corresponding to the bundling-side stacking unit 21 in which the bundling-object-banknotes to be drawn out are stacked, that is, to a position where an upper surface of the lower hand 41B is lower than the bottommost banknote of the bundling-object-banknotes stacked in the bundling-side stacking unit 21 (see FIG. 8A).

Meanwhile, the upper hand 41A of the transport unit 42 of the pre-bundling transport unit 25 is moved upward, through the action of the driving belt 41C, to a position where an upper surface of the upper hand 41A is higher than the topmost banknote of the bundling-object-banknotes stacked in the bundling-side stacking unit 21 (see FIG. 8A). Thus, there is a wide gap between the upper hand 41A and the lower hand 41B.

The transport unit 42 is moved forward through the action of the driving belt 43A of the horizontal movement mechanism 43, and the movement causes the upper hand 41A and the lower hand 41B advance into the bundling-side stacking unit 21 through the opening 31C formed on the back side wall 31B of the bundling-side stacking unit 21 and be positioned such that the bundling-object-banknotes are disposed between the upper hand 41A and the lower hand 41B (see FIG. 8B).

The upper hand 41A of the transport unit 42 is moved downward through the action of the driving belt 41C, so that the bundling-object-banknotes on the stage member 32 are tightly held between the upper hand 41A and the lower hand 41B (see FIG. 8C).

Thereafter, the transport unit 42 moves backward through the action of the driving belt 43A of the horizontal movement mechanism 43, and thus, the bundling-object-banknotes P held by the upper hand 41A and the lower hand 41B are ready to be transported to the operation preparation position on the bundling stage 22A inside the bundling unit 22 or the loose-banknotes returning outlet 24 by the vertical movement mechanism 44 (see FIG. 8D).

The drive control unit 150 shown in FIG. 6 performs the drive control of the pre-bundling transport unit 25 so that, when the number of the bundling-object-banknotes stacked in the bundling-side stacking unit 21 reaches one hundred, the hand unit 41 of the transport unit 42 inside the pre-bundling transport unit 25 advances into the stacking space 31 through the opening 31C of the back side wall 31B, holds the long-edge of the bundling-object-banknotes on the stage unit 32, and draws out the held bundling-object-banknotes from the bundling-side stacking unit 21 in order to transport the drawn bundling-object-banknotes to the bundling unit 22 by the horizontal movement mechanism 43, the vertical movement mechanism 44 and the horizontal movement mechanism 43.

Furthermore, at the end of the transaction when the number of the bundling-object-banknotes stacked in the bundling-side stacking unit 21 does not reach one hundred, the drive control unit 150 performs the drive control of the pre-bundling transport unit 25 so that the hand unit 41 of the transport unit 42 advances into the stacking space 31 through the opening 31C of the back side wall 31B, holds the long-edge of the bundling-object-banknotes on the stage unit 32, and draws out the held loose banknotes of the bundling-object-banknotes from the bundling-side stacking unit 21 in order to transport the drawn loose banknotes to the loose-banknotes returning outlet 24 by the horizontal movement mechanism 43, the vertical movement mechanism 44 and the horizontal movement mechanism 43.

After the bundling-object-banknotes stacked in the bundling-side stacking unit 21 are drawn out, the drive control unit 150 raises the stage member 32 arranged in the bundling-side stacking unit 21 and returns it to a normal standby position for waiting banknotes to be stacked therein.

If a transport error is detected by the detection sensor 19 when the banknote is upstream of a first reject unit 17B, the drive control unit 150 subsequently transports the banknote to the first reject unit 17B.

If a transport error is detected by the detection sensor 19 when the banknote is downstream of the first reject unit 17B, the drive control unit 150 performs the drive control of the banknote transport unit 13 and the diverting units 13A so that the banknote is transported to the second reject unit 20. When transport errors such as skewed state of the banknote on the banknote transport path 18, or chained banknotes on the banknote transport path 18, or double feed of the banknotes on the banknote transport path 18, etc., occur downstream of the first reject unit 17B, that is, on the second transport path 18B or the third transport path 18C, recovery can be achieved quickly by transporting the error banknotes to the second reject unit 20, as compared with stopping the transport of the banknotes.

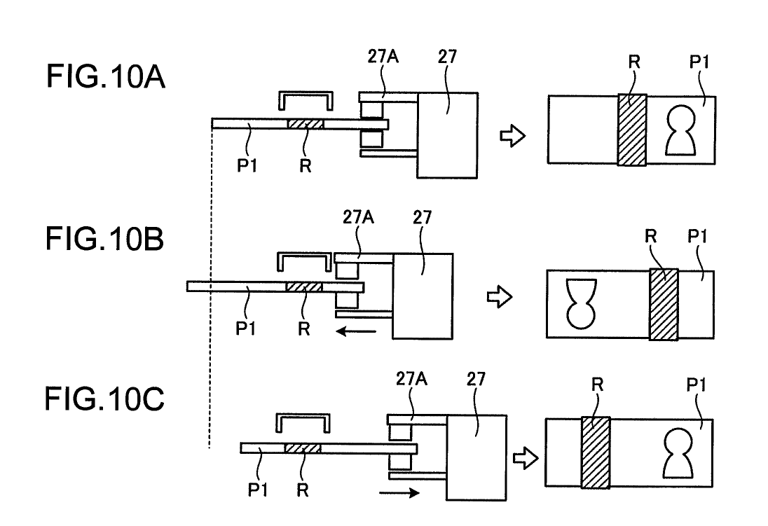

FIGS. 9A to 9G are drawings for clearly explaining action transitions of the hold and transport unit 27 and FIGS. 10A to 10C are drawings for clearly explaining action transitions of the hold and transport unit 27 on the bundling stage 22A.

In FIG. 9, the transport unit 42 of the pre-bundling transport unit 25 holds the long-edge of the bundling-object-banknotes P stacked in the bundling-side stacking unit 21 and transports the bundling-object-banknotes P to near an entrance of the bundling unit 22 through the horizontal movement mechanism 43 and the vertical movement mechanism 44 (see FIG. 9A). As shown in FIG. 9A, the holding unit 27A of the hold and transport unit 27 is arranged at the operation preparation position on the bundling stage 22A.

The transport unit 42 of the pre-bundling transport unit 25 transports the bundling-object-banknotes onto the bundling stage 22A inside the bundling unit 22 through the horizontal movement mechanism 43 (see FIG. 9B), and subsequently to the operation preparation position on the bundling stage 22A (see FIG. 9C). As a result, the holding unit 27A of the hold and transport unit 27 holds the short-edge of the bundling-object-banknotes P at the operation preparation position as the bundling-object-banknotes P are transported to the operation preparation position by the transport unit 42 (see FIG. 9C).

As the holding unit 27A of the hold and transport unit 27 holds the bundling-object-banknotes P, the transport unit 42 of the pre-bundling transport unit 25 releases its hold of the long-edge of the bundling-object-banknotes P (see FIG. 9D), and returns to the normal standby position for the stacked bundling-object-banknotes.

Based on the bundling position set by the bundling-position setting unit 174, the holding unit 27A of the hold and transport unit 27 moves the bundling-object-banknotes P in the long-edge direction so that the bundling position of the bundling-object-banknotes P is aligned with the bundling operation position on the bundling stage 22A (see FIG. 9E). Furthermore, the bundling unit 22 wraps the bundling tape R around the bundling-object-banknotes P at the bundling position that is aligned with the bundling operation position on the bundling stage 22A, and tightens the bundling tape R at the bundling position of the bundling-object-banknotes P in a state the short-edge of the bundling-object-banknotes P are being held by the holding unit 27A.

In FIG. 10A, when the bundling position of the bundling-object-banknotes P held by the holding unit 27A is set to a center portion, the holding unit 27A aligns the bundling operation position with the center portion that is the bundling position of the bundling-object-banknotes P. The bundling unit 22 wraps and tightens the bundling tape R around the center portion of the bundling-object-banknotes P, and makes a bundle of banknotes P1.

In FIG. 10B, when the bundling position of the bundling-object-banknotes P held by the holding unit 27A is set to an end portion on the holding side of the bundling-object-banknotes P, the holding unit 27A aligns the bundling operation position with the end portion on the holding side. The bundling unit 22 wraps and tightens the bundling tape R around the end portion on the holding side of the bundling-object-banknotes P, and makes the bundle of banknotes P1.

In FIG. 10C, when the bundling position of the bundling-object-banknotes P held by the holding unit 27A is set to an end portion that is opposite to the holding side of the bundling-object-banknotes P, the holding unit 27A aligns the bundling operation position with the end portion that is opposite to the holding side. The bundling unit 22 wraps and tightens the bundling tape R around the end portion opposite to the holding side of the bundling-object-banknotes P, and makes the bundle of banknotes P1.

At next step, the holding unit 27A of the hold and transport unit 27 moves the bundle of banknotes P1 that was aligned with the bundling operation position on the bundling stage 22A to the operation preparation position (see FIG. 9F) and transports it to the dispensing transport unit 28 (see FIG. 9G).

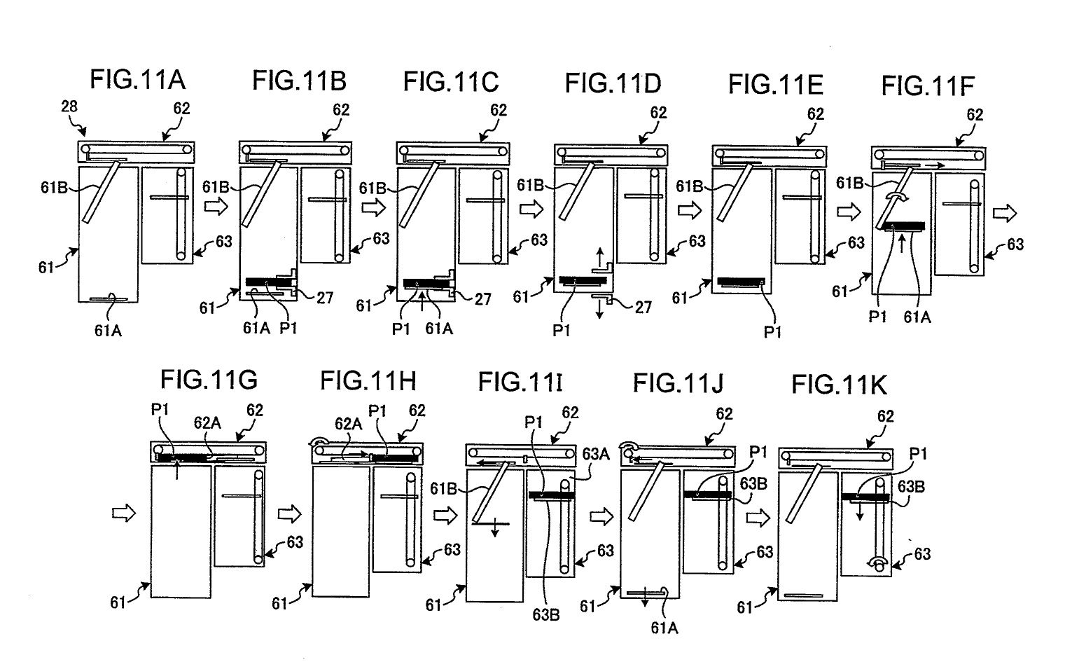

FIGS. 11A to 11K are drawings for clearly explaining action transitions of the dispensing transport unit 28 of the post-bundling transport unit 26.

A transport lift 61A, for placing the bundle of banknotes P1 held and transported by the hold and transport unit 27, of the bundled-banknotes lifting unit 61 of the dispensing transport unit 28 is at the bottommost position in a standby state (see FIG. 11A).

The bundle of banknotes P1 is held and transported to a position above the transport lift 61A of the bundled-banknotes lifting unit 61 by the hold and transport unit 27 (see FIG. 11B). The transport lift 61A on the bundled-banknotes lifting unit 61 side is raised up to the bundle of banknotes P1 so that the bundle of banknotes P1 rests thereon (see FIG. 11C). Thereafter, the hold and transport unit 27 releases its hold of the bundle of banknotes P1 (see FIG. 11D), and moves to the operation preparation position (see FIG. 11E).

Thereafter, the bundled-banknotes lifting unit 61 raises the transport lift 61A on which the bundle of banknotes P1 is placed. A push transport unit 62A of the pushing mechanism 62 attains a pushed status by a link mechanism 61B as the transport lift 61A rises (see FIG. 11F), and the bundle of banknotes P1 placed on the transport lift 61A is set on the push transport unit 62A (see FIG. 11G).

The push transport unit 62A pushes and transports the bundle of banknotes P1 thereon towards the bundle dispensing outlet 23 (see FIG. 11H) located on the front face of the apparatus.

Thereafter, the bundled-banknotes lifting unit 61 lowers the transport lift 61A to the bottommost position. The push transport unit 62A returns to its original standby state by the action of the link mechanism 61B which is moved with the lowering action. The bundle of banknotes P1 is stacked in the bundled-banknotes stacking unit 63A present inside the dispense/hold mechanism 63 (see FIGS. 11I and 11J).

The dispense/hold mechanism 63 adjusts the position of the bundled banknotes stage 63B inside the bundled-banknotes stacking unit 63A so that the topmost bundle of banknotes P1 among those stacked in the bundled-banknotes stacking unit 63A is held at the position of the bundle dispensing outlet 23 (see FIG. 11K).

In the claims of the present application, a banknote bundling device corresponds to the banknote bundling device 3, a bundling-side stacking unit corresponds to the bundling-side stacking unit 21, a bundling unit corresponds to the bundling unit 22, a bundle transport unit corresponds to the pre-bundling transport unit 25 and the hold and transport unit 27, a banknote-information acquisition unit corresponds to the banknote recognition unit 14 and the banknote-kind acquisition unit 172, a bundling-position setting unit corresponds to the bundling-position managing unit 173, the bundling-position setting unit 174, and the drive control unit 150.

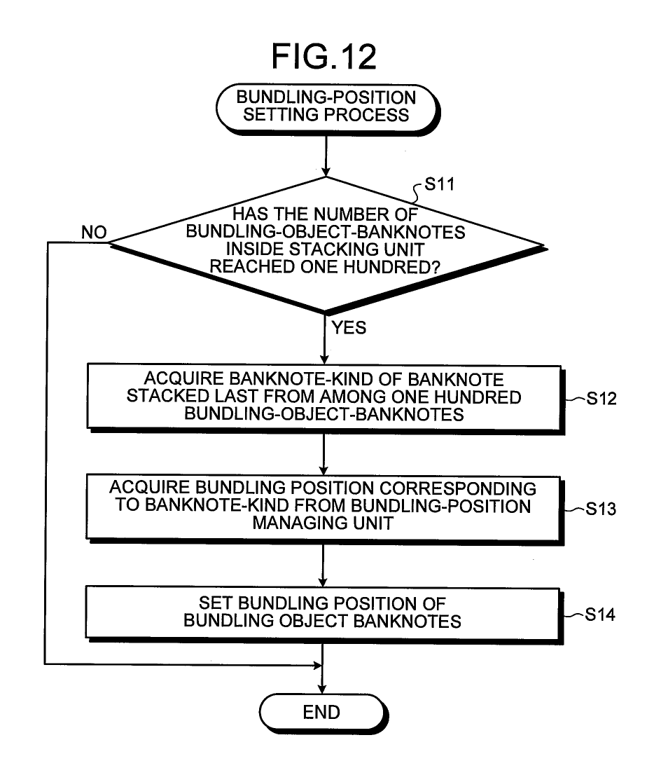

Operations performed by the banknote sorting and bundling apparatus 1 according to the present embodiment are explained below. FIG. 12 is a flowchart of a process procedure performed by the control unit 170 in a bundling-position setting process.

The bundling-position setting process shown in FIG. 12 is a process in which the bundling position of the bundling-object-banknotes is set based on the banknote-kind of the last banknote stacked in the bundling-side stacking unit 21 from among the one hundred bundling-object-banknotes when the number of the bundling-object-banknotes stacked in the bundling-side stacking unit 21 reaches one hundred.

The bundling-object-banknote number determining unit 171 of the control unit 170, shown in FIG. 12, determines whether the number of the bundling-object-banknotes stacked in the bundling-side stacking unit 21 has reached one hundred (Step S11).

The banknote-kind acquisition unit 172 of the control unit 170 acquires the banknote-kind of the last bundling-object-banknote from among the stacked bundling-object-banknotes in the bundling-side stacking unit 21 when the number of the stacked bundling-object-banknotes reaches one hundred (Yes at Step S11) (Step S12).

When the banknote-kind of the bundling-object-banknote, that is stacked last, is acquired, the bundling-position setting unit 174 of the control unit 170 acquires the bundling position corresponding to the banknote-kind from the bundling-position managing unit 173 (Step S13), sets the bundling position of the bundling-object-banknote acquired from the bundling-position managing unit 173 (Step S14), and ends the process shown in FIG. 12. As a result, based on the bundling position set at Step S14, the drive control unit 150 controls the hold and transport unit 27 so that the bundling position of the bundling-object-banknotes is aligned with the bundling operation position on the bundling stage 22A.

The banknote-kind acquisition unit 172 ends the process shown in FIG. 12 when the number of the bundling-object-banknotes does not reach one hundred (No at Step S11).

In the bundling-position setting process shown in FIG. 12, when the number of the bundling-object-banknotes stacked in the bundling-side stacking unit 21 reaches one hundred, the banknote-kind of the last banknote from among the stacked one hundred bundling-object-banknotes is acquired and the bundling position corresponding to the acquired banknote-kind is set to the bundling position of the bundling-object-banknotes. Therefore, based on the set bundling position, the hold and transport unit 27 aligns the bundling position of the bundling-object-banknotes with the bundling operation position on the bundling stage 22A and the bundling unit 22 bundles the bundling-object-banknotes with the bundling tape at the bundling position.

Operations performed by the hold and transport unit 27 are explained below.

The hold and transport unit 27 holds the short-edge of the bundling-object-banknotes that are held and transported by the pre-bundling transport unit 25 to the operation preparation position on the bundling stage 22A inside the bundling unit 22.

Furthermore, the hold and transport unit 27 transports the bundling-object-banknotes in the long-edge direction from the operation preparation position to the bundling operation position so that the bundling position of the bundling-object-banknotes is aligned with the bundling operation position on the bundling stage 22A.

The bundling unit 22 makes the bundle of banknotes by bundling the bundling-object-banknotes after a leading edge of the bundling tape is stopped by the bundling tape stopper 52 at the bundling position of the bundling-object-banknotes that is aligned with the bundling operation position on the bundling stage 22A, the bundling tape is wrapped by the swinging arm 53 around the bundling-object-banknotes at the bundling position, the other end of the bundling tape is cut by the cutter 54, and the end of the bundling tape cut by the cutter 54 is thermally bonded by the heater 55.

Thereafter, the hold and transport unit 27 transports the bundle of banknotes arranged at the bundling operation position on the bundling stage 22A to the operation preparation position and subsequently to the bundled-banknotes lifting unit 61 inside the dispensing transport unit 28.

After transporting the bundle of banknotes into the bundled-banknotes lifting unit 61, the hold and transport unit 27 releases its hold of the short-edge of the bundle of banknotes. Consequently, the dispensing transport unit 28 transports the bundle of banknotes to the dispensing holding mechanism 63 via the bundled-banknotes lifting unit 61 and the pushing mechanism 62.

In the present embodiment, the bundling position of the bundling tape on the bundling-object-banknotes is set based on the banknote-kind of the last banknote from among the stacked one hundred bundling-object-banknotes in the bundling-side stacking unit 21. Therefore, the bundling position on the bundling-object-banknotes can be freely set without requiring a complex mechanism.

In the present embodiment, the bundling-object-banknotes on the bundling stage 22A inside the bundling unit 22 can be moved in the long-edge direction of the banknote in a state the short-edge of the bundling-object-banknotes is being held by the hold and transport unit 27, and the bundling-object-banknotes can be moved and adjusted so that the bundling position of the bundling-object-banknotes is aligned with the bundling operation position on the bundling stage 22A. Therefore, the bundling-object-banknotes on the bundling stage 22A can be bundled in the state the short-edge of the bundling-object-banknotes is being held by the hold and transport unit 27. Thus, a situation where the bundling-object-banknotes are not aligned before bundling can be avoided without requiring a complex mechanism, and bundling operation efficiency can be significantly improved by increasing the bundling operation speed.

In the present embodiment, the bundling-object-banknotes are bundled with the bundling tape in a state the bundling-object-banknotes are being held by the hold and transport unit 27, and the bundle of banknotes, that is still being held by the hold and transport unit 27, is transported towards the bundle dispensing outlet 23. Therefore, because the bundling-object-banknotes are held by the hold and transport unit 27 even during the bundling operation, the operation speed for transporting the bundle of banknotes towards the bundle dispensing outlet 23 can be significantly increased.

In the present embodiment, the banknote-kind of the last banknote from among the stacked one hundred bundling-object-banknotes is acquired, and the bundling position corresponding to the banknote-kind is set as the bundling position of the bundling-object-banknotes. However, the same advantages can be realized even when the banknote-kind of the first banknote from among the stacked one hundred bundling-object-banknotes is acquired and the bundling position corresponding to the banknote-kind of the first banknote is set as the bundling position of the bundling-object-banknotes.

In the present embodiment, the bundling position is set for each banknote-kind of the bundling-object-banknote. However, there are countries where wrapping the bundling tape on a portrait printed on a surface of the banknote is prohibited. Therefore, in such a case, position information of the portrait printed on the surface of the bundling-object-banknotes is managed, and based on such position information of the portrait, the bundling position of the bundling tape on the bundling-object-banknotes can be set such that the bundling tape is not wrapped over the portrait printed on the bundling-object-banknotes. Thus, even situations, where wrapping the bundling tape over the portrait printed on the bundling-object-banknotes is prohibited, can be freely handled.

In the present embodiment, the bundling position is set for each denomination of the bundling-object-banknotes. However, instances, when the bundling position of the bundling tape on the bundling-object-banknotes is set based on whether the bundling-object-banknotes are fit notes or unfit notes, can also be taken into consideration. In such a case, the bundling position of the bundling tape can be set on the bundling-object-banknotes based on the fitness information, the fit notes or unfit notes. Thus, the user can identify the fitness of the bundle of banknotes by the bundling position of the bundling tape.

For example, when the bundling-object-banknotes are the unfit notes, the bundling position can be set to a center portion of the bundling-object-banknotes. Thus, the user can identify the unfit banknotes by the bundling tape wrapped around the center portion of the bundling-object-banknotes.

Furthermore, when the bundling-object-banknotes are the unfit notes, the bundling positions can be set to a plurality of positions on the bundling-object-banknotes. Thus, the user can identify the unfit banknotes by the bundling tapes wrapped around the plurality of positions of the bundling-object-banknotes.

In the present embodiment, the bundling position is set for each denomination of the bundling-object-banknotes. However, instances, when the bundling position of the bundling tape on the bundling-object-banknotes is set based on the printed version information, that is, whether the bundling-object-banknotes are new notes or old notes, can also be taken into consideration. In such a case, the bundling position of the bundling tape can be set on the bundling-object-banknotes based on the printed version information, new notes or old notes. Thus, the user can identify whether the bundled banknotes are new notes or old notes by the bundling position of the bundling tape.

In the present embodiment, the same bundling position is set when the banknote-kind is the same. However, when the bundles of banknotes having the same bundling position are sequentially placed and stacked, side edge, opposite to the bundling position, of the bundles of banknotes becomes higher than the bundling position. Therefore, to handle such a case, the normal bundling position and the opposite bundling position that is opposite to the normal bundling position are managed, and the normal bundling position or the opposite bundling position is sequentially set in an alternating manner each time the bundling-object-banknotes of the same banknote-kind are bundled. Therefore, even when a plurality of the bundles of the same banknote-kind are stacked, the bundles of banknotes are stacked flatly, and the bundles of banknotes can be stably stacked.

In the present embodiment, the same bundling position is set when the banknote-kind is the same. However, after the bundling position of the bundling tape on the bundling-object-banknotes is set, the number of times the bundling-object-banknotes of the same denomination is bundled with the bundling tape at the bundling position is counted, and when the number of times reaches a predetermined value, for example, five, another bundling position is set at a predetermined distance, for example, 10 mm, from the previously set bundling position in the long-edge direction of the banknote. Thus, when the denominations of the bundles of banknotes are the same, the user can freely perform counting of the bundles of banknotes because the bundling position is shifted by 10 mm in the long-edge direction of the banknote after the predetermined number of the bundles of banknotes, for example, five, that is, after every five bundles of banknotes.

In the present embodiment, among the three bundling-side stacking units 21, the one bundling-side stacking unit 21 is set as spare and the different denominations are set for the remaining two bundling-side stacking units 21 as stacking banknotes. However, the same advantages can be realized even if the same denominations are set for the remaining two bundling-side stacking units 21.

In the present embodiment, when the number of the bundling-object-banknotes stacked in the bundling-side stacking unit 21 reaches one hundred, the transport unit 42 of the pre-bundling transport unit 25 draws out the bundling-object-banknotes and transports them onto the bundling stage 22A inside the bundling unit 22. However, the same advantages can be realized even when the transport unit 42 transports the drawn out bundling-object-banknotes to near an entrance of the bundling unit 22, and the holding unit 27A of the hold and transport unit 27 holds the short-edge of the bundling-object-banknotes near the entrance of the bundling unit 22 and transports them to the operation preparation position on the bundling stage 22A.

In the present embodiment, the banknote bundling device 3 that bundles the bundling-object-banknotes with the bundling tape is explained as an example. However, the same advantages can be realized even when paper sheets such as gift coupons and valuable securities are bundled with the bundling tape.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth. The advantages of the present embodiment are not limited to those stated here.

All the automatic processes explained in the present embodiment can be, entirely or in part, carried out manually by a known method. Similarly, all the manual processes explained in the present embodiment can be, entirely or in part, carried out automatically by a known method. The process procedures, the control procedures, specific names, and data, including various parameters, mentioned in the description and drawings can be changed as required unless otherwise specified.

The constituent elements of the apparatus illustrated are merely conceptual and may not necessarily physically resemble the structures shown in the drawings. For example, the apparatus need not necessarily have the structure that is illustrated. The apparatus as a whole or in parts can be broken down or integrated either functionally or physically in accordance with the load or how the device is to be used.

Each processing function performed by the apparatus can be entirely or partially performed by a CPU (Central Processing Unit) (or a micro computer such as an MPU (Micro Processing Unit) and an MCU (Micro Controller Unit)), or a computer program executed by the CPU (or the micro computer such as the MPU and the MCU), or a hardware using wired logic.

### INDUSTRIAL APPLICABILITY

The banknote bundling device according to the present invention can be used in the financial institutions, etc., because the bundling position of the bundling tape on the bundling-object-banknotes is set based on the banknote information of the banknote that is stacked first or last in the bundling-object-banknotes stacking unit from among a predetermined number of the bundling-object-banknotes, and therefore, the bundling position of the bundling-object-banknotes can be freely set without requiring a complex mechanism.

1. A banknote bundling device comprising:
a bundling-side stacking unit in which bundling-object-banknotes are stacked;
a bundling unit that bundles a predetermined number of the bundling-object-banknotes stacked in the bundling-side stacking unit with a bundling tape;
a banknote-information acquisition unit that acquires banknote information from the bundling-object-banknotes; and
a bundling-position setting unit that sets a bundling position of the bundling tape on the bundling-object-banknotes based on the banknote information, which is acquired by the banknote-information acquisition unit.

2. The banknote bundling device according to claim 1, wherein the bundling-position setting unit sets the bundling position of the bundling tape on the bundling-object-banknotes, based on position information based on the banknote information, such that the bundling tape is not wrapped over the portrait on the bundling-object-banknote.

3. The banknote bundling device according to claim 1, wherein the bundling-position setting unit sets the bundling position of the bundling tape on the bundling-object-banknotes based on banknote condition information included in the banknote information.

4. The banknote bundling device according to claim 3, wherein the bundling-position setting unit sets, based on the banknote condition information including fitness identification information that identifies whether banknotes are fit notes or unfit notes, the bundling position of the bundling tape at a center portion of the bundling-object-banknotes when the banknotes are unfit notes.

5. The banknote bundling device according to claim 3, wherein the bundling-position setting unit sets, based on the banknote condition information including fitness identification information that identifies whether banknotes are fit notes or unfit notes, the bundling positions of the bundling tapes at a plurality of positions on the bundling-object-banknotes when the banknotes are the unfit notes.

6. The banknote bundling device according to claim 1, wherein the bundling-position setting unit sets the bundling position of the bundling tape on the bundling-object-banknotes based on denomination information included in the banknote information.

7. The banknote bundling device according to claim 1, wherein the bundling-position setting unit manages bundling positions that are at one end and at the other end in a long-edge direction of the banknote, and sequentially sets the bundling position at one end or at the other end, in an alternating manner, each time the bundling-object-banknotes are bundled with the bundling tape by the bundling unit.

8. The banknote bundling device according to claim 1, wherein the bundling-position setting unit counts, after the bundling position of the bundling tape on the bundling-object-banknotes is set, number of times the bundling-object-banknotes of the same denomination is bundled by the bundling unit with the bundling tape at the set bundling position, and sets another bundling position at a predetermined distance from the previously set bundling position in a long-edge direction of the banknote each time the number of times reaches a predetermined value.

9. The banknote bundling device according to claim 1, wherein the bundling-position setting unit sets the bundling position of the bundling tape on the bundling-object-banknotes based on denomination information and issued printed version information included in the banknote information.

10. The banknote bundling device according to claim 1, further includes a bundle transport unit that transports, when the number of the bundling-object-banknotes stacked in the bundling-side stacking unit reaches a predetermined number, the predetermined number of the bundling-object-banknotes to the bundling unit; and wherein
the bundle transport unit transports the bundling-object-banknotes to the bundling unit in a state an edge of the bundling-object-banknotes is being held, and enables the bundling-object-banknotes to move in a direction parallel to long-edge of the banknote inside the bundling unit in the state the edge of the bundling-object-banknotes is being held, and
the bundling unit bundles the bundling-object-banknotes with the bundling tape in the state the edge of the bundling-object-banknotes is being held by the bundle transport unit.

11. The banknote bundling device according to claim 10, wherein the bundle transport unit holds a short-edge of the bundling-object-banknotes.

12. A banknote bundling device comprising:
a bundling-side stacking unit in which bundling-object-banknotes are stacked;
a bundling unit that bundles the bundling-object-banknotes with a bundling tape; and
a bundle transport unit that transports, when the number of the bundling-object-banknotes stacked in the bundling-side stacking unit reaches a predetermined number, the predetermined number of the bundling-object-banknotes to the bundling unit,
wherein the bundling unit bundles the bundling-object-banknotes with the bundling tape in a state the bundling-object-banknotes are being held by the bundle transport unit.

13. The banknote bundling device according to claim 12, wherein the bundle transport unit transports the bundling-object-banknotes to the bundling unit in a state a short-edge of the bundling-object-banknotes is being held.

14. The banknote bundling device according to claim 13, wherein the bundle transport unit transports a bundle of banknotes out of the bundling unit after the bundling-object-banknotes are bundled by the bundling unit with the bundling tape.

15. A banknote bundling method for bundling bundling-object-banknotes with a bundling tape using a banknote bundling device including
a bundling-side stacking unit in which the bundling-object-banknotes are stacked, and
a bundling unit that bundles a predetermined number of the bundling-object-banknotes stacked in the bundling-side stacking unit with the bundling tape,
the banknote bundling method comprising:
acquiring banknote information of a banknote stacked first or last as the bundling-object-banknote, and
setting a bundling position of the bundling tape on the bundling-object-banknotes based on the banknote information.

16. A banknote bundling method for bundling bundling-object-banknotes with a bundling tape using a banknote bundling device including
a bundling-side stacking unit in which the bundling-object-banknotes are stacked,
a bundling unit that bundles the bundling-object-banknotes with the bundling tape, and
a bundle transport unit that transports, when the number of the bundling-object-banknotes stacked in the bundling-side stacking unit reaches a predetermined number, the predetermined number of the bundling-object-banknotes to the bundling unit,
the banknote bundling method comprising:
bundling the bundling-object-banknotes with the bundling tape by the bundling unit in a state the bundling-object-banknotes are being held by the bundle transport unit.

17. The banknote bundling device according to claim 1, wherein the bundling-position setting unit sets the bundling position based on the banknote information acquired from at least one of the bundling-object-banknotes stacked in the bundling-side stacking unit.

18. The banknote bundling device according to claim 2, wherein the bundling-position setting unit sets the bundling position based on the banknote information acquired from the bundling-object-banknote stacked first or last in the bundling-side stacking unit.
